(19) United States
(12) Patent Application Publication
(10) Pub. No.: US 2011/0278098 A1
(43) Pub. Date: Nov. 17, 2011

(54) METHOD FOR ARRANGING THE REEVING OF AN ELEVATOR, METHOD FOR MODERNIZING AN ELEVATOR, AND ELEVATOR

(75) Inventors: Ari KETONEN, Hyvinkaa (FI); Antti SAARELAINEN, Espoo (FI)

(73) Assignee: KONE CORPORATION, Helsinki (FI)

(21) Appl. No.: 13/175,432

(22) Filed: Jul. 1, 2011

Related U.S. Application Data
(63) Continuation of application No. PCT/FI2010/000006, filed on Jan. 29, 2010.

(30) Foreign Application Priority Data
Jan. 30, 2009 (FI) 20090028

(51) Int. Cl. B66B 11/08; B23P 6/00; B66B 7/06

(52) U.S. Cl. 187/266; 29/402.03

(57) ABSTRACT

A method for arranging the reeving of an elevator is provided, which elevator comprises at least an elevator car provided with a car sling comprising an overhead beam, a traction sheave and hoisting roping that passes over the traction sheave, as well as a counterweight and a plurality of diverting pulleys. At least two diverting pulleys are disposed on the roof of the elevator car such that the centers of rotation of the diverting pulleys are above the bottom surface of the overhead beam of the car sling, and the rims of the diverting pulleys are below the bottom surface of the overhead beam of the car sling.

The object of the invention is a method for arranging the reeving of an elevator, and an elevator, and a method for modernizing an elevator. The elevator is preferably an elevator that is applicable to passenger traffic.

Generally in elevators, and particularly in geared elevators, the height of the machine room space is a problem. For example, an extra diverting pulley is often needed in the machine room, with which the correct so-called “L dimension” is achieved, in which case the elevator ropes descend at the correct angle to the correct place on the elevator car or on the counterweight. An additional diverting pulley requires its own bedplate in the machine room, which increases the height of the machine. The presence of an extra diverting pulley also necessitates raising the traction sheave higher so that the angle of contact of the ropes on the rim of the traction sheave remains sufficiently large. Thus the overall height grows to be large and e.g. servicing the machine and the brakes might be dangerous and awkward.

Another problem has been that when changing geared elevators to gearless ones in connection with modernization, the height of the machine has increased, in which case the machine room space has remained cramped, or even been more cramped, than before the modernization. In this case servicing jobs, among other things, become more difficult.

The solution according to the invention is particularly suited to modernization, in which a geared elevator must be changed to a gearless elevator. Since changing a geared elevator to a gearless one would normally increase the machine size, an increase in machine size can be avoided by changing the suspension ratio at the same time. The solution according to the invention does not, however, need to be used solely in connection with modernization, but instead an elevator according to the invention is just as well suited also as a first-installation elevator. Likewise the suspension ratio can be other than 2:1, e.g. 3:1 or 4:1.

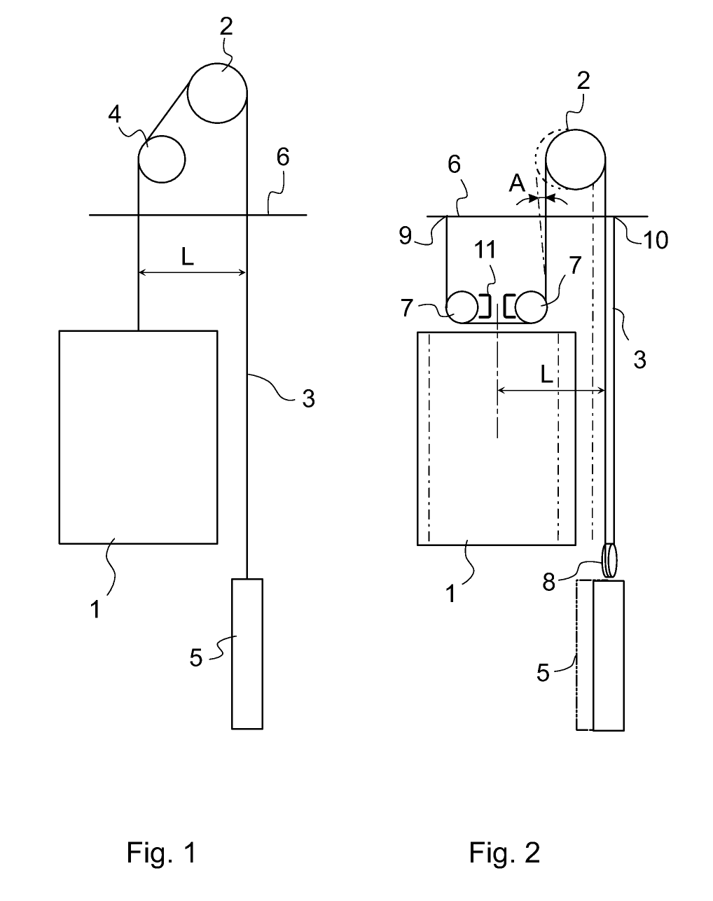

U.S. Pat. No. 5,957,243 presents a 2:1 suspension solution, in which an essentially transverse additional beam is placed below the overhead beam of the car sling, at both ends of and below which additional beam is a diverting pulley. This solution, however, does not endeavor to solve in any way the aforementioned height problem that occurs in the machine room space or the height problem of the top clearance between the roof of the elevator car and the floor of the machine room. On the contrary, e.g. FIG. 1 shows that the structure according to the US patent requires a lot of top clearance above the overhead beam of the car sling of the elevator car. The elevator in question is a first-installation elevator.

The purpose of this our invention is to eliminate the aforementioned drawbacks and to achieve an inexpensive method for arranging the reeving of an elevator that is easy to implement and also very effective. Additionally, the purpose of the invention is to achieve a method by means of which a geared elevator can easily and quickly be modernized into a gearless elevator. Likewise the purpose of the invention is also to achieve an elevator, for which a low machine room is sufficient and in which the top clearance between the roof of the elevator car and the floor of the machine room can be left as small as possible. With the invention it is possible to achieve, among other things, a solution with which 2:1 reeving can be implemented very compactly in both the vertical direction and in the horizontal direction. The method for arranging reeving of the invention is characterized by what is disclosed in the characterization part of claim 1. Correspondingly, the elevator according to the invention is characterized by what is disclosed in the characterization part of claim 14. Correspondingly, the method for modernizing an elevator according to the invention is characterized by what is disclosed in the characterization part of claim 27. Other embodiments of the invention are characterized by what is disclosed in the other claims.

Some inventive embodiments are also discussed in the descriptive section of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise the different details presented in connection with each embodiment can also be applied in other embodiments. In addition it can be stated that at least some of the subordinate claims can in at least some situations be deemed to be inventive in their own right.

One advantage, among others, of the solution according to the invention is that by means of it machine room space as well as top clearance between the floor of the machine room and the roof of the elevator can be saved. Another advantage is that by means of the invention the reeving arrangements and modernization of elevators can be improved. In this case e.g. modernizations of gearless elevators can be expanded to sites where the L dimensions have been in practice unachievable for conventional solutions owing to the shallow machine room. Owing to the shallow bedplate, another advantage is also that servicing of the machine and, in particular, of its brakes in the machine room is facilitated. Another advantage is that modernizations of elevators can be expanded to sites where the top clearances have not permitted installation of diverting pulleys above the overhead beam of the car sling. One advantage also is better energy economy, which will be a benefit to residents and housing companies. Better energy economy is a consequence of being able to utilize better motor technology, drive technology and control technology when modernizing by means of the solution according to the invention, in which case e.g. waste energy can be supplied back to the electricity network. Yet one more advantage of the solution is that an old car and car sling can be used in connection with modernization, so that old elevator components cannot be utilized in the new arrangement. Another advantage is also that the safety of the elevator improves in an embodiment wherein a machinery brake is arranged in connection with the traction sheave to brake the traction sheave without transmissions. More particularly, upwardly directed overspeed situations of the car can be more safely prevented than before.

In the method according to the invention for arranging the reeving of an elevator in an elevator, which comprises at least an elevator car provided with a car sling comprising an overhead beam, a traction sheave and hoisting roping that passes over the traction sheave, as well as a counterweight and a plurality of diverting pulleys, at least one or more diverting pulleys are disposed on the roof of the elevator car such that the centers of rotation of the diverting pulleys are above the bottom surface of the overhead beam of the car sling, and the rims of the diverting pulleys extend to below the bottom surface of the overhead beam of the car sling.

In one embodiment of the invention, at least two diverting pulleys are disposed on the roof of the elevator car such that the rims of the diverting pulleys are disposed below the bottom surface of the overhead beam of the car sling such that the hoisting ropes fit to pass between the overhead beam and the roof of the elevator car.

In one embodiment of the invention, when an old, geared elevator provided with 1:1 suspension, and with a diverting pulley disposed in the machine room that determines the L dimension, and with a counterweight, is being modernized to a gearless elevator, the diverting pulley and the old machine are taken out of the machine room, and also a new machine is disposed in the machine room, and the suspension is changed to be 2:1 by disposing at least two diverting pulleys on the roof of the elevator car such that the centers of rotation of the diverting pulleys are below the bottom surface of the overhead beam of the car sling, and in that the rims of the diverting pulleys are below the bottom surface of the overhead beam of the car sling, and in that the counterweight is provided with a diverting pulley. A gearless machine can be arranged e.g. by arranging a machine in which an electric motor in fixed connection with the traction sheave co-axially rotates the traction sheave.

The elevator according to the invention comprises at least an elevator car suspended on hoisting ropes and provided with a car sling comprising an overhead beam, a traction sheave, and at least one or more diverting pulleys disposed in connection with the elevator car, via which diverting pulley(s) the hoisting rope coming to the elevator car from above is guided to pass below the overhead beam and to be directed back upwards, and also which elevator comprises at least a counterweight provided with a diverting pulley. The one or more diverting pulleys disposed in connection with the elevator car are essentially on the side of the overhead beam.

In one embodiment of the invention the horizontal distance between the diverting pulleys of the elevator is adjustable.

In one embodiment of the invention the axes of rotation of the diverting pulleys of the elevator are parallel with the axis of rotation of the traction sheave.

In one embodiment of the invention the diverting pulleys of the elevator are in the lateral direction on different sides of the overhead beam, preferably so that the axes of rotation of the diverting pulleys are parallel with the overhead beam.

In one embodiment of the invention, in the method for arranging or modernizing the reeving the trimmer beams are at a right angle to the overhead beam. Thus a space-efficient elevator is achieved that is simple in the routing of ropes and in the suspension of the car.

In one embodiment of the invention the hoisting roping of the elevator is arranged to ascend from the diverting pulley of the elevator car, which diverting pulley is at least partly below the traction sheave, at an inclination all the way to the traction sheave.

In one embodiment of the invention the diverting pulleys of the elevator are fixed to the trimmer beams, which enables adjustment of the horizontal distance between diverting pulleys and the fixing of them to the desired distance from each other.

In one embodiment of the invention the plurality of parallel hoisting ropes comprised in the hoisting roping of the elevator descend from the traction sheave to the diverting pulley without the hoisting ropes that descend from the traction sheave to the diverting pulley twisting in the longitudinal direction in relation to each other.

In one embodiment of the invention the traction sheave of the elevator is disposed in the horizontal direction close to the counterweight so that the hoisting ropes descend from the traction sheave to the counterweight essentially at an angle of 0 degrees with respect to the perpendicular.

In one embodiment of the invention the hoisting ropes of the elevator descend from the traction sheave to the diverting pulley on the elevator car essentially at an angle of over 0 degrees with respect to the perpendicular, preferably at an angle of 1-5 degrees, most preferably such that when the car is in its top position the hoisting ropes descend to the diverting pulley at an angle of 3-5 degrees. Thus the arrangement can be implemented also in elevators in which the combined width of the overhead beam of the car sling and the diverting pulleys is large compared to the width of the elevator hoistway.

In one embodiment of the invention, in connection with the elevator car are two diverting pulleys on the roof of the elevator car so disposed that the centers of rotation of the diverting pulleys are above the bottom surface of the overhead beam of the car sling, and the rims of the diverting pulleys are below the bottom surface of the overhead beam of the car sling.

In one embodiment of the invention the diverting pulleys are fixed to trimmer beams that are below the overhead beam of the elevator car by means of support plates that point upwards.

In one embodiment of the invention the rope grooves of the diverting pulleys are disposed to extend to essentially below the top surface of the trimmer beams and the centers of rotation of the diverting pulleys are disposed above the top surface of the trimmer beams.

In one embodiment of the invention the trimmer beams comprise a plurality of consecutive fixing holes for adjusting the horizontal distance between diverting pulleys.

In the method according to the invention for modernizing an elevator, a geared elevator with 1:1 suspension is changed to a gearless elevator, and at the same time the suspension of the elevator car from 1:1 suspension to 2:1 suspension, and the hoisting ropes are guided to pass from the traction sheave to a diverting pulley fixed to the elevator car, from which diverting pulley the hoisting ropes are guided to pass to a second diverting pulley fixed to the elevator car and then upwards to their fixing point. The aforementioned diverting pulleys are arranged on the roof of the elevator car at a horizontal distance from each other. An advantage of this is that a geared machine can be changed to a gearless one in a space-efficient manner. Changing the suspension ratio, among other things, reduces the need for growth in the machine size.

In one embodiment of the invention the hoisting ropes are arranged to pass below the overhead beam of the car sling. An advantage of this is improvement of the space efficiency of a modernization solution. Since the hoisting ropes pass between the car roof of the elevator and the overhead beam of the car sling, the need for top clearance between the elevator car and the roof of the hoistway decreases.

In one embodiment of the invention, the centers of rotation of the aforementioned diverting pulleys are arranged to above the level of the bottom edge of the overhead beam and the rims of the diverting pulleys to extend to below the level of the bottom edge of the overhead beam.

In one embodiment of the invention, the horizontal distance between the aforementioned diverting pulleys is adjusted to be suitable.

In one embodiment of the invention, the old machine is replaced with a new machine, which comprises a traction sheave rotated by an electric motor, and a machinery brake, which is arranged to act on the traction sheave gearlessly. In this case the brake is preferably arranged to act directly on the traction sheave, or on a part that is in fixed connection with the traction sheave and that rotates when the traction sheave rotates. In this case the brake is preferably a brake based on friction, which in the braking position presses against the traction sheave, or against a part that is in fixed connection with the traction sheave, e.g. against a cylindrical part that rotates co-axially with the traction sheave. Thus the problem of a geared machine, that the brake acts on the motor, is avoided. If the shaft between the machine and the gear breaks or the teeth of the gear rupture, the brake has no effect on the traction sheave, which is able to rotate freely. In this case in an underloaded situated with counterweight the car would leave at an accelerating speed downwards.

In one embodiment of the invention, a geared machine with traction sheave is taken out and a new gearless machine with traction sheave is installed, and the diverting pulley guiding the ropes from the traction sheave to the counterweight is taken out along with the old machine and new holes are made in the floor of the machine room. At the same time, therefore, the electric motor of the machine is changed.

In one embodiment of the invention, in the method for arranging or modernizing the reeving the hoisting ropes coming to the elevator car from above are guided to pass, by means of the aforementioned diverting pulleys, below the overhead beam and are directed back upwards.

In one embodiment of the invention, in the method for arranging or modernizing the reeving the hoisting roping is arranged to ascend from the diverting pulley of the elevator car, which diverting pulley is at least partly below the traction sheave, at an inclination all the way to the traction sheave. Thus the arrangement can be implemented also in elevators in which the combined width of the overhead beam of the car sling and the diverting pulleys is large compared to the width of the elevator hoistway.

In one embodiment of the invention, in the method for arranging or modernizing the reeving the horizontal distance of the aforementioned diverting pulleys is adjusted to be suitable. Thus the diverting pulleys can be adjusted to such a distance from each other that the ropes ascend to the traction sheave at an advantageous angle. This is done preferably in connection with installation. The diverting pulleys are thus simple to install in, among other things, modernization in elevators that are different in their dimensions. Owing to this the beams 12 can be installed in different elevators regardless of the dimensions of the elevator at a right angle to the overhead beam such that the centers of rotation of the diverting pulleys and of the traction sheave are parallel.

In one embodiment of the invention, in the method for arranging or modernizing the reeving the diverting pulleys are fixed to the trimmer beams, which enables adjustment of the horizontal distance between diverting pulleys and the fixing of them to the desired distance from each other. Thus adjustment of the distance of the diverting pulleys is simple.

In one embodiment of the invention, in the method for arranging or modernizing the reeving the trimmer beams 12 are arranged at a right angle to the overhead beam. Thus a space-efficient elevator is achieved that is simple in the routing of ropes and in the suspension of the car.

In one embodiment of the invention, in the method for arranging or modernizing the reeving the diverting pulleys are disposed so that their axes of rotation are parallel with the axis of rotation of the traction sheave. Thus the hoisting ropes can be guided upwards without intertwisting of them. The solution is simple and compact in its entirety.

In one embodiment of the invention, in the method for arranging or modernizing the reeving the diverting pulleys are fixed to trimmer beams that are below the overhead beam. Thus the trimmer beams are arranged to be supported on the overhead beam of the elevator car from below. Thus the trimmer beams can be arranged to pass below the overhead beam and to surely prevent detachment of the trimmer beams from the elevator car.

In one embodiment of the invention, in the method for arranging or modernizing the reeving the diverting pulleys are disposed so that in the lateral direction they are on different sides of the overhead beam, preferably so that the axes of rotation of the diverting pulleys are parallel with the overhead beam. Thus a space-efficient and simple elevator with central support is achieved.

In one embodiment of the invention, in the method for arranging or modernizing the reeving the traction sheave and the diverting pulley to which the hoisting ropes of the hoisting roping descend from the traction sheave are disposed in relation to each other such that the plurality of parallel hoisting ropes comprised in the hoisting roping descend from the traction sheave to the diverting pulley without the hoisting ropes that descend from the traction sheave to the diverting pulley twisting in the longitudinal direction in relation to each other. Thus the solution is simple.

In one embodiment of the invention, in the method for arranging or modernizing the reeving the traction sheave is disposed in the horizontal direction close to the counterweight so that the hoisting ropes descend from the traction sheave to the counterweight essentially at an angle of 0 degrees.

In one embodiment of the invention, in the method for arranging or modernizing the reeving the hoisting ropes are arranged to descend from the traction sheave to the diverting pulley on the elevator car at an angle of essentially over 0 degrees, which angle is preferably 7 degrees at maximum, more preferably 5 degrees at maximum, most preferably such that when the car is in its top position the hoisting ropes (3) descend to the diverting pulley (7) at an angle of 3-5 30 degrees. The aforementioned angle is preferably however over 1 degree.

In the following, the invention will be described in detail by the aid of one example of its embodiments with reference to the simplified and diagrammatic drawings attached, wherein

FIG. 1 presents a simplified and diagrammatic side view of one typical 1:1 elevator suspension, in which there is an additional diverting pulley in the machine room,

FIG. 2 presents a simplified and diagrammatic side view of one 2:1 elevator suspension, in which the additional diverting pulley has been taken out of the machine room

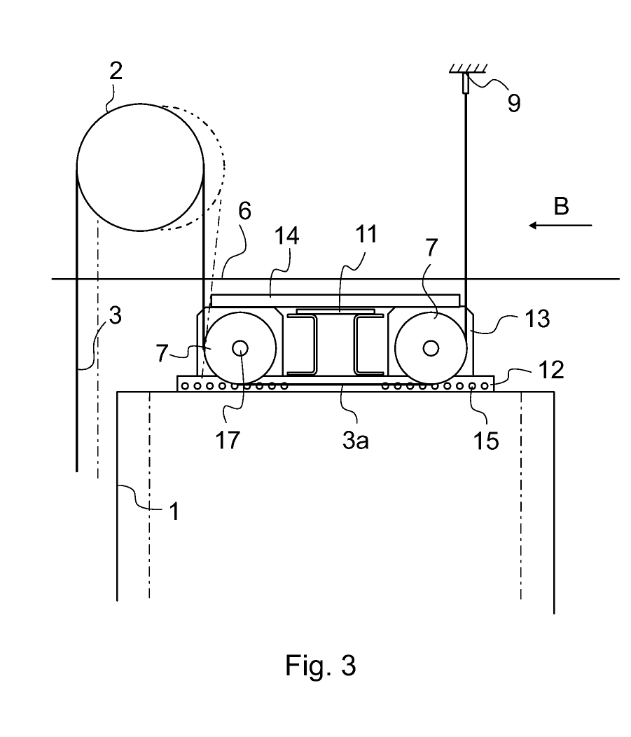

FIG. 3 presents a simplified and diagrammatic side view of the suspension according to FIG. 2 above the elevator car in more detail and partly sectioned and

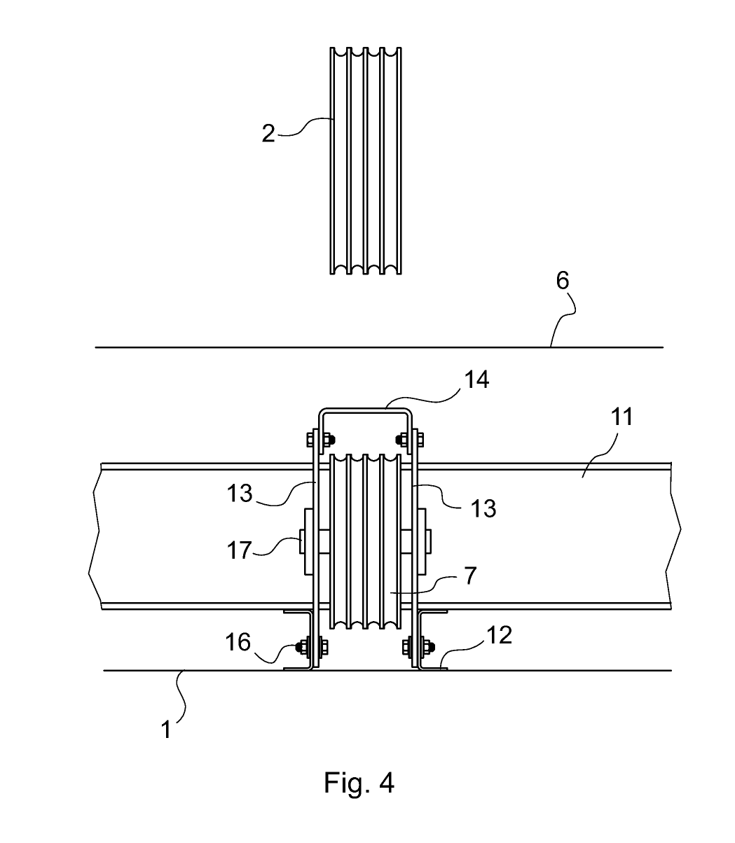

FIG. 4 presents the solution according to FIG. 3 in more detail as viewed from the direction of the arrow B of FIG. 3.

FIG. 1 presents a simplified and diagrammatic side view of one typical 1:1 elevator suspension implemented with a geared machine, in which there is an additional diverting pulley 4 in the machine room. The elevator car 1 is suspended on the hoisting rope 3 at its first end, which hoisting rope is placed to pass over the top of the traction sheave 2 on the hoisting machine, after passing around which the hoisting rope 3 descends to the counterweight 5, to which it is fixed at its second end. Only one rope is presented in connection with the description and in the figures, but in reality the hoisting roping comprises a number of parallel ropes of the same size. A sufficiently large horizontal distance, i.e. the so-called L dimension, must be achieved between the sections of rope descending to the elevator car 1 and to the counterweight 5, so that the elevator car 1 and to the counterweight 5 do not collide with each other when traveling past each other in the elevator hoistway and so that they are in balance in relation to the suspension. The magnitude of the L dimension can be influenced in two ways. One method is to vary the size of the traction sheave 2, but that is not always practicable. Additionally, by increasing the size of the traction sheave 2 the torque required from the machine increases, in which case costs increase and also the size of the elevator becomes a limitation.

FIG. 1 presents the use of an additional diverting pulley 4 in the machine room, as a generally used method, the floor of which machine room is presented with the reference number 6. The additional diverting pulley 4 cannot, however, be disposed absolutely freely to anywhere at all in relation to the traction sheave 2 because an additional diverting pulley 4 that is too close in the height direction produces too short an angle of contact of the rope 3 on the traction sheave 2, which produces too much friction. For this reason the structure according to this solution is often undesirably high in the machine room and the machine is e.g. difficult to service.

FIG. 2 presents an elevator corresponding to FIG. 1 when modernized according to the invention. In this solution the additional diverting pulley affecting the L dimension has been taken out of the machine room and the hoisting machine as well as the traction sheave 2 could be installed considerably lower than in the structure according to FIG. 1. In the solution according to the invention the rope suspension is changed at the same time to 2:1 suspension such that two essentially similar diverting pulleys 7 are disposed on the roof of the elevator car 1 and one diverting pulley 8 on the counterweight 5. The first end 9 of the hoisting rope 3 is fixed to some suitable fixed point on the roof of the elevator hoistway or in the machine room, from which fixing point the hoisting rope 3 is guided under the diverting pulleys 7 on the roof of the elevator car 1 such that at the same time the hoisting rope 3 goes under the essentially horizontal overhead beam 11 of the car sling of the elevator as close to the roof of the elevator car 1 as possible. Nothing of the car sling except a part of the essentially horizontal overhead beam 11 is seen in the simplified FIG. 2. After passing around the bottom of both diverting pulleys 7 the elevator rope ascends to the traction sheave 2, around the top of which it passes and descends down to the diverting pulley 8 of the counterweight 5, around the bottom of which the rope 3 passes and ascends up again to its fixing point 10 of the second end either on the roof of the elevator hoistway or in the machine room. With the placement and size of the traction sheave 2 as well as with the placement and size of the diverting pulleys 7 it is possible to determine the angle A of the hoisting rope 3 ascending from the diverting pulley 7 to the traction sheave 2 with respect to the vertical plane, which angle A, i.e. the so-called side pull of the hoisting rope, is preferably at maximum 7° when the car is in its top position, more preferably at maximum 5°, in which case the scale of magnitude of the side pull does not cause other problems. Side pull is preferably used in the invention e.g. in the types of situations in which the car sling is wide or correspondingly the elevator car is narrow. In this case the diverting pulleys 7 on the roof of the elevator car cannot be close enough to each other, in which case one of the diverting pulleys reaches to below the traction sheave 2. In the aforementioned type of cases, in which side pull would be utilized in a solution of FIG. 2, the hoisting roping would be arranged to ascend from the diverting pulley 7 that is on the right-hand side in the figure slanting to the left all the way up to the traction sheave 2. In this case the diverting pulley on the right-hand side would be at least partly below the traction sheave 2. In this case it would be preferable to install the diverting pulley 7 on the left-hand side so that the diverting pulleys 7 are symmetrically in relation to the joint center of mass of the car and the car sling. In the figure the side pull arrangement, when the diverting pulley 7 is arranged partly below the traction sheave, is shown with a dashed line.

FIGS. 3 and 4 present an elevator solution according to the invention in more detail, but still simplified. In FIG. 3, one trimmer beam 12 and the support plates 13 of the diverting pulleys have been taken away from the front of both diverting pulleys 7 on the side of the viewer in order to clarify the drawing. In the solution according to the invention the space need between the essentially horizontal overhead beam 11 of the car sling and the roof of the elevator car 1 is minimized by disposing the essentially shallow trimmer beams 12 of the diverting pulleys and the shafts 17 of the diverting pulleys 7 below the overhead beam 11 between the roof of the car and the overhead beam 11, i.e. the centers of rotation are fitted above the trimmer beams 12. In this case the positioning of the diverting pulleys 7 is also such that the rims of the diverting pulleys 7 extend to below the bottom surface of the overhead beam 11 and the shafts 17 of the diverting pulleys as well as the centers of rotation of the diverting pulleys extend at the same time to above the bottom surface of the overhead beam 11. More precisely, the rope grooves on the rim of the diverting pulleys 7 in this case also extend to below the bottom surface of the overhead beam 11 so that the hoisting ropes 3 fit to pass below the overhead beam 11. Thus the diverting pulleys are essentially on both sides of the overhead beam 11 of the car sling. The trimmer beams 12 comprise e.g. two parallel and essentially similar U-beams, which are disposed side-by-side at a horizontal distance from each other and with the web plates of the beams face to face. Thus the bottom part of the diverting pulleys 7 fits to rotate between the beams of the trimmer beams 12 below the bottom surface of the overhead beam 11. In this case also the hoisting rope 3 passes between the roof of the elevator car 1 and the bottom surface of the overhead beam 11. This rope section is marked in FIG. 3 with the reference number 3a.

Both diverting pulleys 7 are enclosed inside support plates 13 fixed to the sides of the diverting pulleys 7 and are mounted with bearings on their shafts 17 in the support plates 13. The support plates 13 are fixed at their bottom edge, e.g. with a bolt fixing 16, to fixing holes 15 in the trimmer beams 12, which fixing holes are arranged so that the place of the fixing can be changed when adjusting the horizontal distance between the diverting pulleys 7. The structure of the diverting pulley pack is further reinforced with a support beam 14, with which the different support plates 13 of the diverting pulleys 7 are connected to each other at their top edges.

The dashed line in FIG. 3 presents how side pull can be implemented according to FIG. 2, if desired, e.g. when the outer dimensions of the elevator car are narrow as presented with the dashed line in relation to the space taken up by the diverting pulleys 7. This is therefore preferable when the dimensions of the elevator car/hoistway impede placement of the diverting pulleys close to each other. With these arrangements the beams 12 can be placed in a narrow space at any angle whatsoever in relation to the overhead beam 11, preferably at a right angle, for achieving a simple elevator structure and preferably also a rope ascension to the traction sheave without twisting. The counterweight 5 can thus be arranged to pass near the diverting pulley 7 as presented in FIG. 2 with a dashed line.

In the method according to the invention the reeving arrangement of the elevator is implemented with a 2:1 suspension, e.g. such that a gearless machine is disposed in the machine room in a suitable position in the lateral direction, which machine comprises a traction sheave 2, and at least two diverting pulleys 7 are disposed on the roof of the elevator car 1, one on both sides of the overhead beam 11 of the car sling, such that the centers of rotation of the diverting pulleys 7 are fitted to be above the bottom surface of the overhead beam 11 of the car sling, whereas the rims of the diverting pulleys 7 and also at least the bottoms of the rope grooves on the rim of the diverting pulleys 7 are fitted to be below the level of the bottom surface of the overhead beam 11 of the car sling, so that the hoisting rope 3 and the part 3a of it fit to pass below the overhead beam 11. In the method the hoisting ropes 3 are guided to pass from their fixing position of the first end 9 under the diverting pulleys 7 on the roof of the elevator car 1 such that at the same time the hoisting rope 3 goes under the overhead beam 11 of the car sling of the elevator as close to the roof of the elevator car 1 as possible. After this the elevator ropes are guided to ascend to the traction sheave 2 to pass around the top of the traction sheave 2 and to descend down to the diverting pulley 8 of the counterweight 5, after passing around the bottom of which the rope 3 is guided to ascend up again to its fixing point 10 of the second end either on the roof of the elevator hoistway or in the machine room. The roping 3 descends down to the counterweight 5 preferably at an angle of 0 degrees except for possible twisting.

Correspondingly, in connection with the modernization of an old, geared elevator that is suspended 1:1, the reeving arrangement of the elevator is implemented in the method according to the invention with 2:1 suspension, e.g. such that the old geared machine (in which the rotation speed ratio of the machine and the traction sheave is changed by means of a gear) with its traction sheave 2 and possibly a diverting pulley 4 that determines the L dimension is taken out of the machine room. After this a new gearless machine is disposed in the machine room at a suitable height and in a suitable position in the lateral direction, which machine comprises a traction sheave 2, the speed of rotation of which is the speed of rotation of the motor. In addition, at least two diverting pulleys 7 are disposed on the roof of the elevator car 1, one on both sides of the overhead beam 11 of the car sling, such that the centers of rotation of the diverting pulleys 7 are fitted to be above the bottom surface of the overhead beam 11 of the car sling, whereas the rims of the diverting pulleys 7 and also at least the bottoms of the rope grooves on the rim of the diverting pulleys 7 are fitted to be below the bottom surface of the overhead beam 11 of the car sling, so that the hoisting rope 3 and the part 3a of it fit to pass below the overhead beam 11. Since there will now be more through-entries for the ropes and they are in different positions with respect to the original, also new holes must be made in the floor 6 of the machine room at the point of the through-entries of the ropes. The guiding of the hoisting ropes 3 via the diverting pulleys 7, 8 and the traction sheave 2 is implemented here in essentially the same way as described earlier.

It is obvious to the person skilled in the art that the invention is not limited solely to the examples described above, but that it may be varied within the scope of the claims presented below. Thus for instance the number and placement of the diverting pulleys on the roof of the elevator car can differ to what is presented above. For example, the aforementioned diverting pulleys disposed on the roof of the elevator car could be fixed to the overhead beam or to the roof structure of the car.

1.-42. (canceled)

43. Method for arranging the reeving in an elevator, which elevator comprises at least an elevator car provided with a car sling comprising an overhead beam, a traction sheave and hoisting roping that passes over the traction sheave, as well as a counterweight and a plurality of diverting pulleys, wherein the diverting pulleys are disposed on the roof of the elevator car such that the centers of rotation of the diverting pulleys are above the bottom surface of the overhead beam of the car sling, and the rims of the diverting pulleys extend to below the bottom surface of the overhead beam of the car sling.

44. Method according to claim 43, wherein at least two diverting pulleys are disposed on the roof of the elevator car such that the rims of the diverting pulleys are disposed below the bottom surface of the overhead beam of the car sling so that the hoisting ropes fit to pass between the overhead beam and the roof of the elevator car.

45. Method according to claim 43, wherein the hoisting ropes coming to the elevator car from above are guided by means of the diverting pulleys to pass below the overhead beam and are directed back upwards.

46. Method according to claim 43, wherein the hoisting roping is arranged to ascend from the diverting pulley of the elevator car, which diverting pulley is at least partly below the traction sheave, at an inclination all the way to the traction sheave.

47. Method according to claim 43, wherein in the method the horizontal distance of the diverting pulleys is adjusted to be suitable.

48. Method according to claim 43, wherein in the method the diverting pulleys are fixed to the trimmer beams, which enables adjustment of the horizontal distance between diverting pulleys and the fixing of them to the desired distance from each other.

49. Method according to claim 43, wherein the diverting pulleys are disposed so that their axes of rotation are parallel with the axis of rotation of the traction sheave.

50. Method according to claim 43, wherein in the method the diverting pulleys are fixed to trimmer beams that are below the overhead beam.

51. Method according to claim 43, wherein the diverting pulleys are disposed so that in the lateral direction they are on different sides of the overhead beam, preferably so that the axes of rotation of the diverting pulleys are parallel with the overhead beam.

52. Method according to claim 43, wherein the traction sheave and the diverting pulley to which the hoisting ropes of the hoisting roping descend from the traction sheave are disposed in relation to each other such that the plurality of parallel hoisting ropes comprised in the hoisting roping descend from the traction sheave to the diverting pulley without the hoisting ropes that descend from the traction sheave to the diverting pulley twisting in the longitudinal direction in relation to each other.

53. Method according to claim 43, wherein the traction sheave is disposed in the horizontal direction close to the counterweight so that the hoisting ropes descend from the traction sheave to the counterweight essentially at an angle of 0 degrees.

54. Method according to claim 43, wherein the hoisting ropes are arranged to descend from the traction sheave to the diverting pulley on the elevator car at an angle of over 0 degrees, which angle is preferably 7 degrees at maximum, more preferably 5 degrees at maximum, most preferably such that when the car is in its top position the hoisting ropes descend to the diverting pulley at an angle of 3-5 degrees.

55. Method according to claim 43, wherein when an old, geared elevator provided with 1:1 suspension, and with a diverting pulley disposed in the machine room that determines the L dimension, and with a counterweight, is being modernized to a gearless elevator, the diverting pulley and the old machine are taken out of the machine room, and also a new machine is disposed in the machine room, and the suspension is changed to be 2:1 by disposing at least two diverting pulleys on the roof of the elevator car such that the centers of rotation of the diverting pulleys are above the bottom surface of the overhead beam of the car sling, and the rims of the diverting pulleys are below the bottom surface of the overhead beam of the car sling, and the counterweight is provided with a counterweight.

56. Elevator, which comprises at least an elevator car suspended on hoisting ropes and provided with a car sling comprising an overhead beam, a traction sheave, and at least one or more diverting pulleys disposed in connection with the elevator car, via which diverting pulley the hoisting rope coming to the elevator car from above is guided to pass below the overhead beam and to be directed back upwards, and also which elevator comprises at least a counterweight provided with a diverting pulley, wherein the one or more diverting pulleys disposed in connection with the elevator car are essentially on the side of the overhead beam.

57. Elevator according to claim 56, wherein the horizontal distance between diverting pulleys is adjustable.

58. Elevator according to claim 56, wherein the axes of rotation of the diverting pulleys are parallel with the axis of rotation of the traction sheave.

59. Elevator according to claim 56, wherein the diverting pulleys are in the lateral direction on different sides of the overhead beam, preferably so that the axes of rotation of the diverting pulleys are parallel with the overhead beam.

60. Elevator according to claim 56, wherein the hoisting roping is arranged to ascend from the diverting pulley of the elevator car, which diverting pulley is at least partly below the traction sheave, at an inclination all the way to the traction sheave.

61. Elevator according to claim 56, wherein the diverting pulleys are fixed to the trimmer beams, which enables adjustment of the horizontal distance between diverting pulleys and the fixing of them to the desired distance from each other.

62. Elevator according to claim 56, wherein the plurality of parallel hoisting ropes comprised in the hoisting roping descend from the traction sheave to the diverting pulley without the hoisting ropes that descend from the traction sheave, to the diverting pulley twisting in the longitudinal direction in relation to each other.

63. Elevator according to claim 56, wherein the traction sheave is disposed in the horizontal direction close to the counterweight so that, the hoisting ropes descend from the traction sheave to the counterweight essentially at an angle of 0 degrees.

64. Elevator according to claim 56, wherein the hoisting ropes descend from the traction sheave to the diverting pulley on the elevator car at an angle of over 0 degrees, which angle is preferably 7 degrees at maximum, more preferably 5 degrees at maximum, most preferably such that when the car is in its top position the hoisting ropes descend to the diverting pulley at an angle of 3-5 degrees.

65. Elevator according to claim 56, wherein in connection with the elevator car are two diverting pulleys on the roof of the elevator car so disposed that the centers of rotation of the diverting pulleys are above the bottom surface of the overhead beam of the car sling, and the rims of the diverting pulleys are below the bottom surface of the overhead beam of the car sling.

66. Elevator according to claim 56, wherein the diverting pulleys are fixed to trimmer beams that are below the overhead beam of the elevator car, preferably by means of support plates pointing upwards.

67. Elevator according to claim 56, wherein the rope grooves of the diverting pulleys are disposed to extend to essentially below the top surface of the trimmer beams and the centers of rotation of the diverting pulleys are disposed above the top surface of the trimmer beams.

68. Elevator according to claim 56, wherein in the trimmer beams comprise a plurality of consecutive fixing holes for adjusting the horizontal distance between diverting pulleys.

69. Method for modernizing an elevator, in which method a geared elevator with 1:1 suspension is changed to a gearless elevator, and the suspension of the elevator car from 1:1 suspension to 2:1 suspension, and the hoisting roping is guided to pass from the traction sheave to a diverting pulley fixed to the elevator car, from which diverting pulley the hoisting roping is guided to pass to a second diverting pulley fixed to the elevator car and then upwards to its fixing point, and the diverting pulleys are arranged on the roof of the elevator car at horizontal distance from each other.

70. Method according to claim 69, wherein in the method the hoisting ropes are arranged to pass below the overhead beam of the car sling.

71. Method according to claim 69, wherein the centers of rotation of the aforementioned diverting pulleys are arranged to above the level of the bottom edge of the overhead beam and the rims of the diverting pulleys to extend to below the level of the bottom edge of the overhead beam.

72. Method according to claim 69, wherein the hoisting ropes coming to the elevator car from above are guided to pass by means of the diverting pulleys below the overhead beam and are directed back upwards.

73. Method according to claim 69, wherein the hoisting roping is arranged to ascend from the diverting pulley of the elevator car, which diverting pulley is at least partly below the traction sheave, at an inclination all the way to the traction sheave.

74. Method according to claim 69, wherein in the method the horizontal distance of the diverting pulleys is adjusted to be suitable.

75. Method according to claim 69, wherein in the method the diverting pulleys are fixed to the trimmer beams, which enables adjustment of the horizontal distance between diverting pulleys and the fixing of them to the desired distance from each other.

76. Method according to claim 69, wherein the diverting pulleys are disposed so that their axes of rotation are parallel with the axis of rotation of the traction sheave.

77. Method according to claim 69, wherein in the method the diverting pulleys are fixed to trimmer beams that are below the overhead beam.

78. Method according to claim 69, wherein the diverting pulleys are disposed so that they are in the lateral direction on different sides of the overhead beam, preferably so that the axes of rotation of the diverting pulleys are parallel with the overhead beam.

79. Method according to claim 69, wherein the traction sheave and the diverting pulley to which the hoisting ropes of the hoisting roping descend from the traction sheave are disposed in relation to each other such that the plurality of parallel hoisting ropes comprised in the hoisting roping descend from the traction sheave to the diverting pulley without the hoisting ropes that descend from the traction sheave to the diverting pulley twisting in the longitudinal direction in relation to each other.

80. Method according to claim 69, wherein the traction sheave is disposed in the horizontal direction close to the counterweight so that the hoisting ropes descend from the traction sheave to the counterweight essentially at an angle of 0 degrees.

81. Method according to claim 69, wherein the hoisting ropes are arranged to descend from the traction sheave to the diverting pulley on the elevator car at an angle of over 0 degrees, which angle is preferably 7 degrees at maximum, more preferably 5 degrees at maximum, most preferably such that when the car is in its bottom position the hoisting ropes descend to the diverting pulley at an angle of 3-5 degrees.

82. Method according to claim 69, wherein in the method the old machine is replaced with a new machine, which comprises a traction sheave rotated by an electric motor, and a machinery brake, which is arranged to act on the traction sheave gearlessly.

83. Method according to claim 69, wherein a geared machine with traction sheave is taken out and a new gearless machine with traction sheave is installed, and the diverting pulley guiding the ropes from the traction sheave to the counterweight is taken out along with the old machine and new holes are made in the floor of the machine room.

84. Method according to claim 69, wherein the trimmer beams are arranged at a right angle to the overhead beam.
